(19) United States
(12) Patent Application Publication
(10) Pub. No.: US 2004/0155416 A1
(43) Pub. Date: Aug. 12, 2004

(54) Smooth surface sliding system for ground vehicle

(76) Inventors: Jie Liu, Alhambra, CA (US); Shi Ming Liu, Alhambra, CA (US)

Correspondence Address: Raymond Y. Chan, 108 N. Ynez Ave., Suite 128, Monterey Park, CA, 91754, US

(21) Appl. No.: 10/361,425

(22) Filed: Feb. 11, 2003

(51) Int. Cl. B62M 27/00

(52) U.S. Cl. 280/12.14

(57) ABSTRACT

A smooth surface sliding system, which is adapted for incorporating with a ground vehicle impelled by a pedal driving assembly, includes a pair of supporting arms sidewardly and outwardly extended from the vehicle frame, a pair of driven units includes two driven arms movably coupled with the supporting arms respectively and two ski members coupling with bottom ends of the driven arms respectively for sliding on a smooth surface, and a steering control connected to the driven arms for shifting a downward force of a weight of the ground vehicle between the two ski members so as to increase a friction of the respective ski member with respect to the smooth surface.

### BACKGROUND OF THE PRESENT INVENTION

1. Field of Invention

The present invention relates to a ground vehicle, and more particularly to a smooth surface sliding system for ground vehicle, wherein the ground vehicle is capable of driving on a smooth surface, such as snow or ice surface, in a stabilization manner.

2. Description of Related Arts

Nowadays, athletics have always played a major part in one's day-to-day activities. Bicycle, which is one of the famous athletics, is well known and has been considered as a form of transportation, recreation, and exercise. A conventional bicycle comprises a supporting frame for supporting a rider in a sitting position, two wheel assemblies rotatably mounted to a front portion and a rear portion of the supporting frame respectively, and a transmission system comprising two pedals for propelling the bicycle. It is no doubt that the conventional bicycle is one of the best transporting and exercising tools. However, the conventional bicycle cannot be used over the smooth surface, such as snow, grass, ice surface, or sand.

It is known that the wheels of the conventional bicycle cannot provide enough friction with respect to the smooth surface such that while driving the bicycle, the bicycle tends to skip on the smooth surface. It is dangerous when the rider is riding downhill or making a turn on the smooth surface. Once the rider losses the balance on the bicycle, the rider will fall down on the smooth surface, which may cause an unwanted injury. As a result, the conventional bicycle is limited for only riding on a regular roadway.

### SUMMARY OF THE PRESENT INVENTION

A main object of the present invention is to provide a smooth surface sliding system for a ground vehicle, wherein the rider is able to drive the ground vehicle on the smooth surface, such as snow or ice surface, in a stabilization manner.

Another object of the present invention is to provide a smooth surface sliding system for a ground vehicle, wherein sliding system comprises two ski members spacedly supporting at two sides of the vehicle frame of the ground vehicle on the smooth surface so as to increase the safety distance of the ground vehicle for enhancing the balance thereof while driving on the smooth surface.

Another object of the present invention is to provide a smooth surface sliding system for a ground vehicle that is easy and convenient to use.

Another object of the present invention is to provide a smooth surface sliding system for a ground vehicle, which does not require altering the original structural design of the ground vehicle so as to substantially reduce the manufacturing cost of the ground vehicle to incorporate with the sliding system.

Another object of the present invention is to provide a smooth surface sliding system for a ground vehicle, wherein the sliding system is capable of detaching from the vehicle frame and being substituted with a regular wheel assembly such that the ground vehicle can be not only used as a snow vehicle during snow reason while incorporating with the sliding system but also used as a wheeled vehicle driving on a dry land.

Another object of the present invention is to provide a smooth surface sliding system for a ground vehicle, wherein no expensive or complicated structure is required to employ in the present invention in order to achieve the above mentioned objects. Therefore, the present invention successfully provides an economic and efficient solution for transportation on snow and ice as well as on dry land.

Accordingly, in order to accomplish the above objects, the present invention provides a smooth surface sliding system for a ground vehicle which comprises a vehicle frame comprising a frame body and a control unit mounted to a front portion of the frame body, and a pedal driving assembly supported at a rear portion of the vehicle frame, wherein the smooth surface sliding system comprises:

a pair of supporting arms each having an inner coupling end coupling with the vehicle frame and an outer coupling end sidewardly and outwardly extended from the vehicle frame;

a pair of driven units spacedly positioned at two sides of the vehicle frame wherein the driven units comprise left and right driven arms each having an upper end movably coupled with the outer coupling end of the respective supporting arm, and left and right ski members coupling with bottom end of the left and right driven arms respectively for sliding on a smooth surface; and

a steering control connected to the driven arms for shifting a downward force of a weight of the ground vehicle between the left and right ski members so as to increase a friction of the respective ski member with respect to the smooth surface.

These and other objectives, features, and advantages of the present invention will become apparent from the following detailed description, the accompanying drawings, and the appended claims.

### BRIEF DESCRIPTION OF THE DRAWINGS

FIG. 1 is a side view of a ground vehicle incorporated with a smooth surface sliding system according to a preferred embodiment of the present invention.

FIG. 2 is a front view of the ground vehicle incorporated with the smooth surface sliding system according to the above preferred embodiment of the present invention.

FIG. 3 illustrates a braking system of the smooth surface sliding system according to the above preferred embodiment of the present invention.

FIG. 4 illustrates an alternative mode of the ski member of the smooth surface sliding system according to the above preferred embodiment of the present invention.

FIGS. 5A and 5B illustrate the ski member of the smooth surface sliding system according to the above preferred embodiment of the present invention, illustrating the ski member being substituted by a wheel.

### DETAILED DESCRIPTION OF THE PREFERRED EMBODIMENT

An improved bicycle is equipped with a ski system as one of the wheel assemblies in such a manner that such snow bicycle is capable of driving over the snow. However, the snow bicycle still has many drawbacks. When the bicycle is equipped with the ski system, the original structure of the bicycle must be altered in order to incorporate with the ski member. Such complex structure of the snow bicycle will highly increase the manufacturing cost thereof.

In addition, the control of the snow bicycle with the ski system is one of the biggest problems for the rider to ride over the smooth surface. Accordingly, the snow bicycle will tend to skip on the smooth surface while turning. In other words, the turning operation of the conventional bicycle, which is turning the steering wheel, cannot be used in the snow bicycle. Therefore, the stabilization of the snow bicycle is the main concern for safety purpose.

Also, the wheel assembly must be reconstructed in order to keep the balance of the snow bicycle while driving on a smooth surface of the snow or ice. In other words, by adding the ski system and altering the wheel assembly to the bicycle, the overall weight of the snow bicycle will be highly increased so as to loss the ordinary feature of the bicycle. In addition, the snow bicycle can only be used during the snow reason. Therefore, the rider may merely to purchase the regular bicycle for riding during summer time and an additional snow bicycle for riding during the snow reason. So, an alternative is sought for.

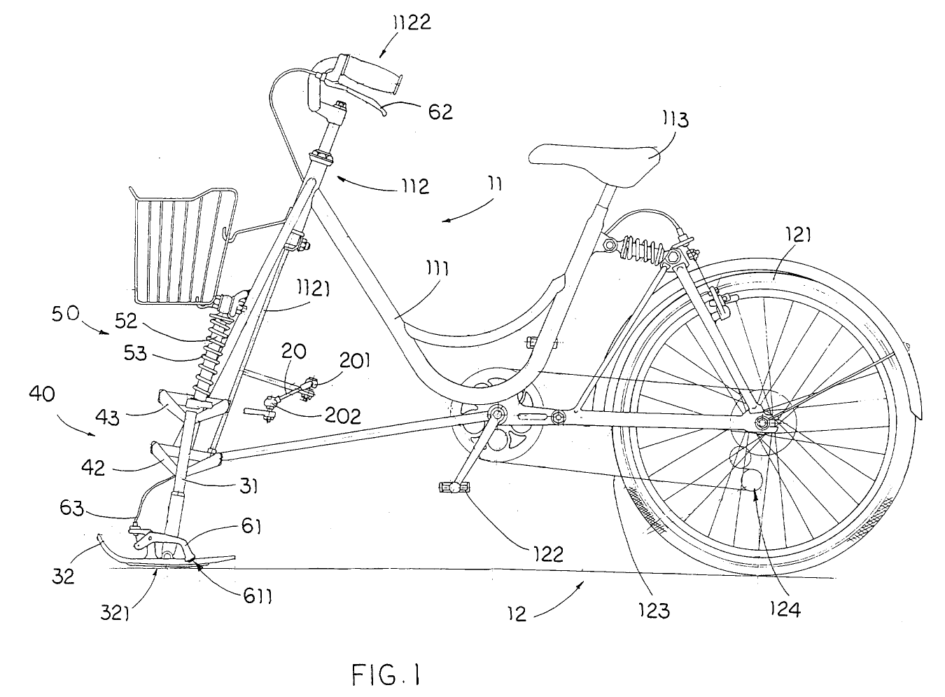

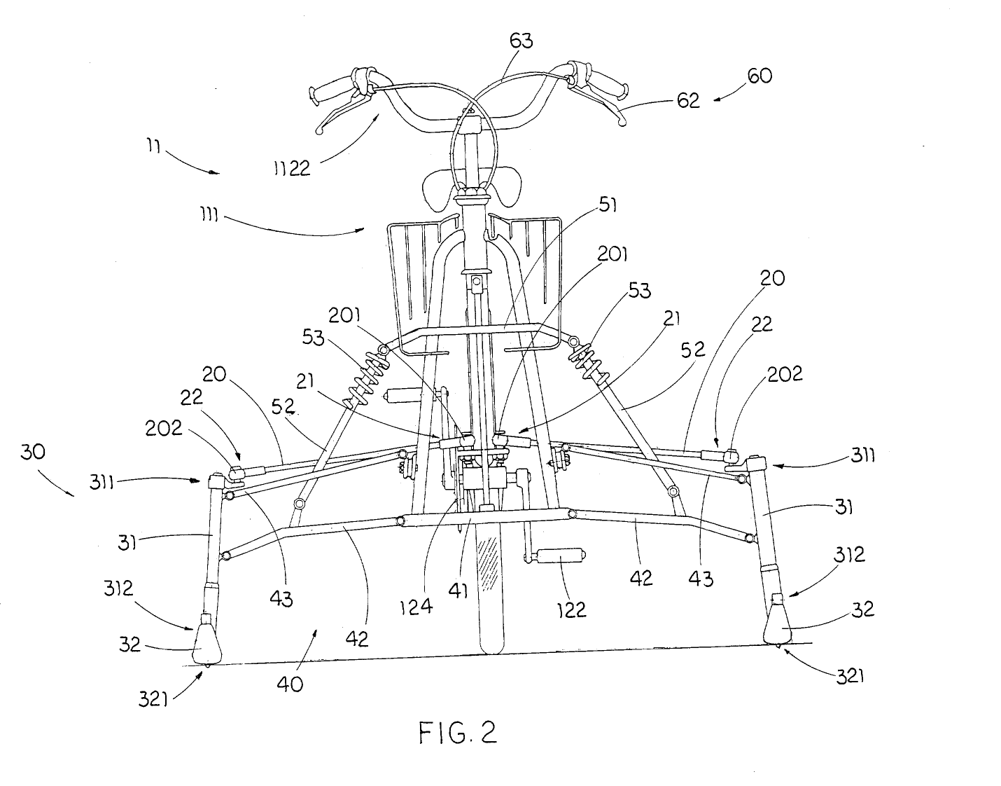

Referring to FIGS. 1 and 2 of the drawings, a ground vehicle incorporated with a smooth surface sliding system according to a preferred embodiment of the present invention is illustrated, wherein the smooth surface sliding system is an improved ski system for not only enhancing the stabilization of the ground vehicle but also enhancing the steering control for the rider.

The ground vehicle, such as a bicycle, comprises a vehicle frame 11 comprising a frame body 111 and a control unit 112 mounted to a front portion of the frame body 111, and a pedal driving assembly 12 supported at a rear portion of the vehicle frame 11.

The smooth surface sliding system comprises a pair of supporting arms 20 each having an inner coupling end 21 coupling with the vehicle frame 111 and an outer coupling end 22 sidewardly and outwardly extended from the vehicle frame 11, a pair of driven units 30 spacedly positioned at two sides of the vehicle frame 11 wherein each of the driven units 30 comprises a driven arm 31 having an upper end 311 movably coupled with the outer coupling end 22 of the respective supporting arm 20, and a ski member 32 coupling with a bottom end of the driven arm 31 for sliding on a smooth surface. The two ski members 32, which are the left and right ski members 32, are positioned at the left and right sides of the vehicle frame 11 respectively.

The smooth surface sliding system further comprises steering control 40 connected to the driven arms 31 for shifting a downward force of a weight of the ground vehicle between the left and right ski members 32 so as to increase a friction of the respective ski member 32 with respect to the smooth surface. Accordingly, when the downward force is applied on the left ski member 32, the ground vehicle tends to turn left. In other words, when the downward force is evenly applied on the two ski members 32, the ground vehicle tends to move forward.

According to the preferred embodiment, the vehicle frame 11 is constructed as a bicycle frame which is made of lightweight but durable material for supporting a rider in a sitting position, wherein the vehicle frame 11 further comprises a seat support 113 upwardly extended from the frame body 111.

The control unit 112 comprises a steering shaft 1121 rotatably attached to the front portion of the frame body 111 of the vehicle frame 11 and a handle frame 1122 provided at an upper portion of the steering shaft 1121.

The pedal driving system 12 comprises a driving wheel 121 rotatably mounted to the rear portion of the frame body 111 of the vehicle frame 11, a pair of pedals 122 rotatably coupling with the vehicle frame 11, and an endless belt 123 connected the pedals 122 to the driving wheel 121 through a gear unit 124 for transmitting a rotational power from the pedals 122 to the driving wheel 121 so as to impel the ground vehicle.

Each of the supporting arms 20 is sidewardly and frontwardly extended from the vehicle frame 11 wherein the inner coupling end 21 of each of the supporting arms 20 is movably coupling with the vehicle frame 11 via a first coupling joint 201.

The upper end 311 of each of the driven arms 31 is movably connected to the outer coupling end 22 of the respective supporting arm 20 via a second coupling joint 202, wherein the bottom end 312 of the each of the driven arms 31 is downwardly extended towards the sliding surface. Accordingly, the driven arms 31 are inclinedly and outwardly extended from the outer coupling ends 22 of the supporting arms 20 respectively in such a manner that a distance between the two ski members 32 is substantially increased to enhance the stabilization of the ground vehicle.

The second coupling joints 202 according to the preferred embodiment are two ball joints connecting the outer coupling ends 22 of the supporting arms 20 with the upper ends 311 of the driven arms 31 for enhancing a movement of each of the driven arms 31 with respect to the respective supporting arm 20.

The ski members 32 are pivotally and detachably connected to the bottom ends of the driven arms 31 respectively, wherein each of the ski members 32 has a sliding guider 321 provided at a bottom surface thereof for minimizing a contacting area between the ski member 32 and the sliding surface, especially on the ice surface.

The steering control 40 comprises two side arms 42 pivotally connected between the two ends of a central shaft 41 of the control unit 112 and the driven arms 31 respectively so as to control the turn of the ground vehicle via the control unit 112 through the side arms 42. In other words, when the downward force is applied on a right side of the handle frame 1122 of the control unit 112, the right ski member 32 of the driven unit 30 is pressed downwardly through the respective side arm 42 to increase the friction between the right ski member 32 and the smooth surface. By controlling the difference of frictional forces on the left and right ski members 32 with respect to the smooth surface, the rider is able to make a turn of the ground vehicle in a stable manner.

For enhancing the stabilization of the ground vehicle, the steering control 40 further comprises a pair of stabilizing arms 43 pivotally connected between the driven arms 31 and two sides of the vehicle frame 11 respectively in such a manner that when the downward force is applied on the respective ski member 32 through the control unit 112 for a turn of the ground vehicle, the stabilizing arms 43 are capable of retaining the driven arms 31 to slide outwardly so as to prevent an unwanted lateral movement of the ski member 32.

The sliding system further comprises a suspension unit 50 which comprises a suspension shaft 51 transversely mounted on the control unit 112, two suspension arms 52 pivotally connected to two outer ends of the suspension shaft 51 with the side arms 42 of the steering control 40 respectively, and two shock absorbing elements 53 mounted on the two suspension arms 52 respectively for absorbing a shock from the respective ski member 32 through the suspension arm 52 while driving the ground vehicle.

The shock absorbing elements 53 according to the preferred embodiment are two compression springs coaxially mounted to the suspension arms 52 in such a manner that the shock absorbing elements 53 are capable of applying a compression force for minimizing the shock on the ski members 32 while the ground vehicle is sliding on the smooth surface.

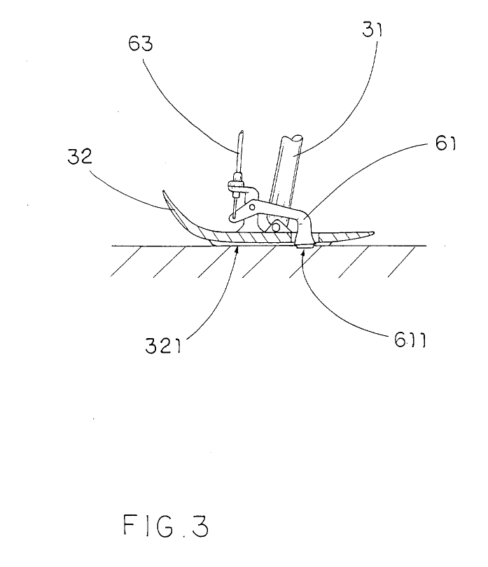

As shown in FIG. 3, the sliding system further comprises a brake system 60 for reducing a speed of the ground vehicle wherein the brake system 60 comprises two braking arms 61, each having a braking head 611, pivotally connected to the ski members 32 respectively, and a brake lever 62 which is coupled with the braking arms 61 via a brake cable 63 and arranged to drive the braking heads 611 of the braking arms 61 for biasing against the smooth surface so as to reduce the speed of the ground vehicle.

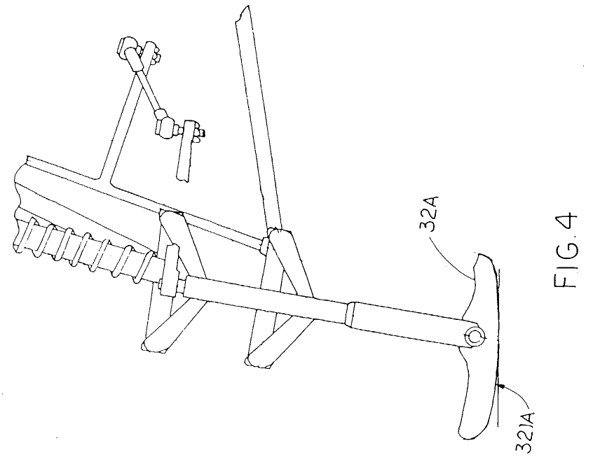

FIG. 4 illustrates an alternative mode of the ski member 32A wherein the ski member 32A can be substituted to have a flat bottom sliding surface 321A for sliding on a smooth surface such as the snow surface.

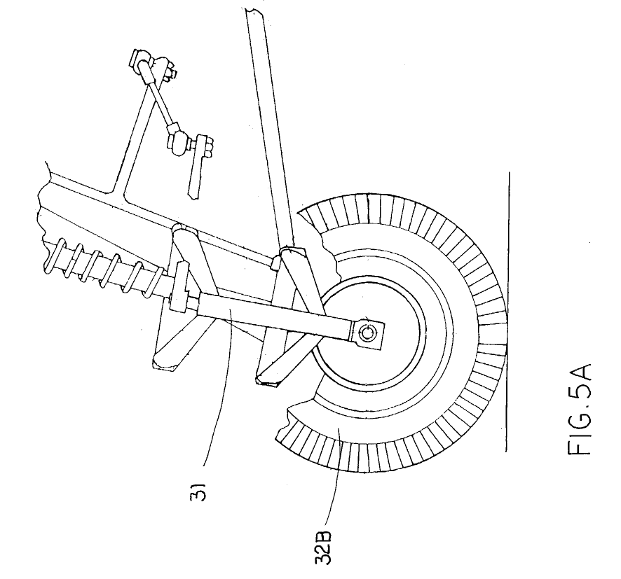

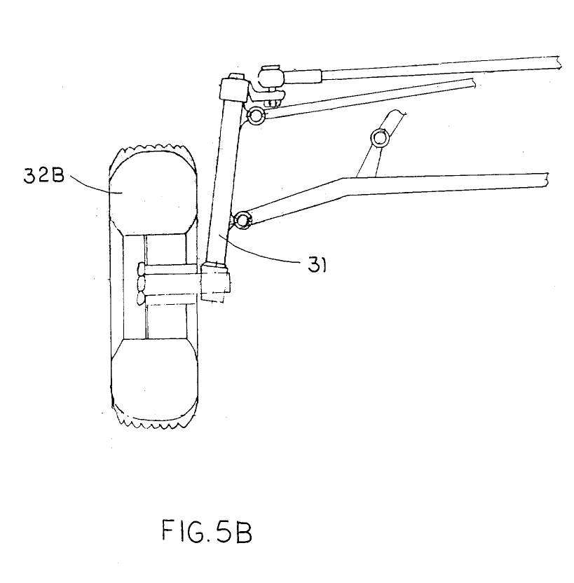

The ski member 32 can be selectively replaced with a wheel 32B as shown in FIGS. 5A and 5B to illustrate that the same vehicle frame 11 can be used in a normal roadway. The rider is able to simply mount the wheel 32B to the driven arm 32 via a wheel hub so that the wheel 32B is rotatably mounted at the bottom end of the driven arm 31 as shown in FIG. 5B. In other words, when the ski members 32 are replaced with the wheel 32B, the ground vehicle is configured as a tricycle so that the rider is able to drive the ground vehicle on the roadway. Therefore, the rider is to able select different kinds of ski member 32 mounting on the driven arms 31 so as to drive the ground vehicle on different kinds of the road condition.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A smooth surface sliding system for a ground vehicle which comprises a vehicle frame comprising a frame body and a control unit mounted to a front portion of said frame body, and a pedal driving assembly supported at a rear portion of said vehicle frame, wherein said smooth surface sliding system comprises:
a pair of supporting arms each having an inner coupling end adapted for coupling with said vehicle frame and an outer coupling end sidewardly and outwardly extended from said vehicle frame;
a pair of driven units spacedly positioned at two sides of said vehicle frame wherein said driven units comprises left and right driven arms each having an upper end movably coupled with said outer coupling end of said respective supporting arm, and left and right ski members coupling with bottom ends of said left and right driven arms respectively for sliding on a smooth surface; and
a steering control comprising two side arms pivotally connected said left and right driven arms respectively for coupling with said control unit of said vehicle frame, wherein said steering control is arranged for shifting a downward force of a weight of said ground vehicle between said left and right ski members so as to increase a friction of one of said ski members with respect to said smooth surface.

2. The smooth surface sliding system, as recited in claim 1, wherein said driven arms are inclinedly and outwardly extended from said outer coupling ends of said supporting arms respectively for substantially increasing a distance between said two ski members.

3. The smooth surface sliding system, as recited in claim 1, wherein said steering control further comprises a pair of stabilizing arms pivotally connected to said driven arms for coupling with two sides of said frame body respectively, so as to retain said driven arms in position.

4. The smooth surface sliding system, as recited in claim 2, wherein said steering control further comprises a pair of stabilizing arms pivotally connected to said driven arms for coupling with two sides of said frame body respectively, so as to retain said driven arms in position.

5. The smooth surface sliding system, as recited in claim 1, further comprising a suspension unit which comprises a suspension shaft for transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

6. The smooth surface sliding system, as recited in claim 2, further comprising a suspension unit which comprises a suspension shaft for transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

7. The smooth surface sliding system, as recited in claim 4, further comprising a suspension unit which comprises a suspension shaft for transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

8. The smooth surface sliding system, as recited in claim 1, wherein said ski member are pivotally and detachably connected to said bottom ends of said driven arms respectively.

9. The smooth surface sliding system, as recited in claim 4, wherein said ski member are pivotally and detachably connected to said bottom ends of said driven arms respectively.

10. The smooth surface sliding system, as recited in claim 7, wherein said ski member are pivotally and detachably connected to said bottom ends of said driven arms respectively.

11. The smooth surface sliding system, as recited in claim 1, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle.

12. The smooth surface sliding system, as recited in claim 7, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle.

13. The smooth surface sliding system, as recited in claim 10, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle.

14. A ground vehicle for driving on a smooth surface, comprising:
a vehicle frame comprising a frame body and a control unit mounted to a front portion of said frame body;
a pedal driving assembly supported at a rear portion of said vehicle frame; and
a smooth surface sliding system, comprising:
a pair of supporting arms each having an inner coupling end coupling with said vehicle frame and an outer coupling end sidewardly and outwardly extended from said vehicle frame;
a pair of driven units spacedly positioned at two sides of said vehicle frame wherein said driven units comprises left and right driven arms each having an upper end movably coupled with said outer coupling end of said respective supporting arm, and left and right ski members coupling with bottom ends of said left and right driven arms respectively for sliding on a smooth surface; and
a steering control comprising two side arms which are pivotally connected said left and right driven arms respectively and coupling with said control unit of said vehicle frame, wherein said steering control is arranged for shifting a downward force of a weight of said ground vehicle between said left and right ski members so as to increase a friction of said respective ski member with respect to said smooth surface, in such a manner that when said downward force is shifted to said left ski member, said ground, vehicle tends to turn left, and when said downward force is shifted to said right member, said ground vehicle tends to turn right.

15. The ground vehicle, as recited in claim 14, wherein said driven arms are inclinedly and outwardly extended from said outer coupling ends of said supporting arms respectively for substantially increasing a distance between said two ski members so as to enhance a stabilization of said ground vehicle.

16. The ground vehicle, as recited in claim 14, wherein said steering control further comprises a pair of stabilizing arms pivotally connected between said driven arms and two sides of said frame body respectively, so as to retain said driven arms in position.

17. The ground vehicle, as recited in claim 15, wherein said steering control further comprises a pair of stabilizing arms pivotally connected between said driven arms and two sides of said frame body respectively, so as to retain said driven arms in position.

18. The ground vehicle, as recited in claim 14, further comprising a suspension unit which comprises a suspension shaft transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

19. The ground vehicle, as recited in claim 15, further comprising a suspension unit which comprises a suspension shaft transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

20. The ground vehicle, as recited in claim 17, further comprising a suspension unit which comprises a suspension shaft transversely mounting on said control unit, two suspension arms pivotally connected to two outer ends of said suspension shaft with said steering control, and two shock absorbing elements mounted on said two suspension arms respectively for absorbing a shock from said respective ski member through said suspension arm.

21. The ground vehicle, as recited in claim 14, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle

22. The ground vehicle, as recited in claim 17, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle

23. The ground vehicle, as recited in claim 19, further comprising a brake system which comprises two braking arms, each having a braking head, pivotally connected to said ski members respectively, and a brake lever which is coupled with said braking arms and arranged to drive said braking heads of said braking arms for biasing against said smooth surface to reduce a speed of said ground vehicle.
